(19) United States
(12) Patent Application Publication
(10) Pub. No.: US 2004/0075339 A1
(43) Pub. Date: Apr. 22, 2004

(54) Unit for an electronically regulated braking system

(76) Inventor: Peter Volz, Darmstadt (DE)

Correspondence Address: RATNERPRESTIA, P O BOX 980, VALLEY FORGE, PA, 19482-0980, US

(21) Appl. No.: 10/466,587

(22) PCT Filed: Feb. 4, 2002
(86) PCT No.: PCT/EP02/01128

(30) Foreign Application Priority Data
Feb. 2, 2001 (DE) 101 04 637.5

(51) Int. Cl. B60T 8/40

(52) U.S. Cl. 303/116.4

(57) ABSTRACT

The present invention relates to a unit for an electronically controlled brake system including a motor (2) that drives a pump (21) by way of a shaft (3, 4), said pump being arranged in a valve or pump block (1) and supplying hydraulic fluid into wheel brakes of the brake system. A controller unit (11) is provided on a side of the valve or pump block (1) opposite to the motor (2). The unit further includes at least one sensor (12, 13, 14) for sensing the rotational speed of the motor (2) or the shaft (3, 4). According to the invention, at least one sensor element (14) of the sensor (12, 13, 14) is arranged in the area of the controller unit (11) in order to reduce the mounting space required for the unit, lower the production costs and simplify signal transmission.

The present invention relates to a unit for an electronically controlled brake system including a motor that drives a pump by way of a shaft, said pump being arranged in a valve or pump block and supplying hydraulic fluid into wheel brakes of the brake system, and a controller unit provided on a side of the valve or pump block opposite to the motor, wherein the unit comprises at least one sensor for sensing the rotational speed of the motor or the shaft.

Electronically controlled brake systems are generally known in the art and used in particular in motor vehicles. There are different systems or control arrangements such as anti-lock systems (ABS), traction slip control systems (TCS), electronic stability programs (ESP), or electro-hydraulic brake systems (EHB). A large number of units for brake systems of this type are known from the state of the art. The present invention principally allows being employed in all of these brake systems, but it is appropriate for electro-hydraulic brake systems (EHB) in particular.

The exact knowledge of engine speed data is of increasing significance in modern electronically controlled brake systems. The information about the exact engine speed is, among others, taken into consideration for controlling the rate of delivery of the pump, for reducing the noise of motor or pump, and for safeguarding the overall safety concept of the brake system.

Various control systems for a brake system are presently known wherein during idling or coasting of a non-energized motor the output generator voltage is used to generate the rotational speed information or speed signal. This method is very inaccurate because it is sensitive to many disturbing influences such as friction, voltage fluctuations in the electrical system of the motor vehicle, or the condition of a collector or of brushes of the motor.

In addition, there are control systems or motors where an additional brush operates on the collector and the voltage variation at this brush is taken into account for generating the rotational speed signal. This method is also very inaccurate and difficult to master. Especially in non-brush, electronically commutating motors the above-mentioned methods cannot be used to generate a rotational speed signal so that separate sensors for sensing the speed signal may be required in this case, for example.

Accordingly, motors are known in the art wherein additional sensors are arranged in the interior of the motor. A motor of this type is e.g. disclosed in U.S. Pat. No. 6,127,752. A relatively large mounting space is required in the interior of said motor, and additionally the transmission of the rotational speed signal to a corresponding evaluating unit or to the controller unit of the electronically controlled brake system becomes relatively complicated, said system being typically arranged on the side of the valve or pump block opposite to the motor.

This is why additional line connections to the controller unit are necessary in the presently known arrangements of sensors in the interior of the motor. These electric connections may be realized by way of additional cables between motor and controller unit, and plugs or fastening points may be required in addition. In this respect, also a solution is possible where the electric connections for transmitting the rotational speed signal are passed directly through the valve or pump block. However, the disadvantage of this solution is that it necessitates additional mounting space between the hydraulic ducts or construction elements such as the pump or various valves arranged in the valve or pump block, which is not easily available.

In view of the above, an object of the present invention is to improve upon a unit for an electronically controlled brake system to such effect that the mounting space required by the unit is minimized, while additionally enabling a safe and simple transmission of the speed signal. Another objective is to achieve low-cost manufacture for the unit.

This object is achieved according to the invention in that in a unit for an electrically controlled brake system, at least one sensor element of the sensor is provided in the area of the controller unit. Thus, the invention arranges for an electrical contacting between the sensor element that receives or relays a speed signal and the controller unit to extend within the controller unit, thereby obviating the need for additional external lines or any different electrical contacting through the valve or pump block compared to a sensor that is entirely arranged in the interior of the motor. This arrangement permits creating a low-cost and small size unit and a safe and simple transmission of the rotational speed signal.

Advantageously, the controller unit includes a board, and the sensor element is connected preferably directly to the board by way of electrical contacting. In the contacting, i.e., between sensor element and board, there may also be provision of a plug connection in particular so that separation of valve block or pump block and controller unit is possible. This is because the controller unit is configured as an independent component according to a particularly preferred embodiment of the present invention.

E.g. an optical sensor or a magneto-sensitive sensor with an optical or magneto-sensitive sensor element may be provided as a sensor. Possible examples of an optical sensor are sensors functioning by means of laser, infrared, or a photoelectric cell. The use of several sensors monitoring each other is also feasible for safety reasons.

Preferably, a coding element of the sensor is unrotatably arranged on the shaft or on components co-rotating with the shaft such as an eccentric of the pump. The coding element may e.g. be magnetic or at least include an optical contrast.

It is particularly advantageous to provide especially a cover between the coding element and the sensor element. Said cover prevents e.g. hydraulic or lubricating fluid out of a crank chamber of the pump from contaminating or damaging the sensor element. Corresponding to the above-mentioned sensor variants the cover may have an anti-magnetic and/or transparent design.

Further features and details of the invention will be explained more closely in the following description by way of embodiments making reference to the accompanying drawings. Features and interrelations described in individual variants may principally be applied to all embodiments. In the drawings,

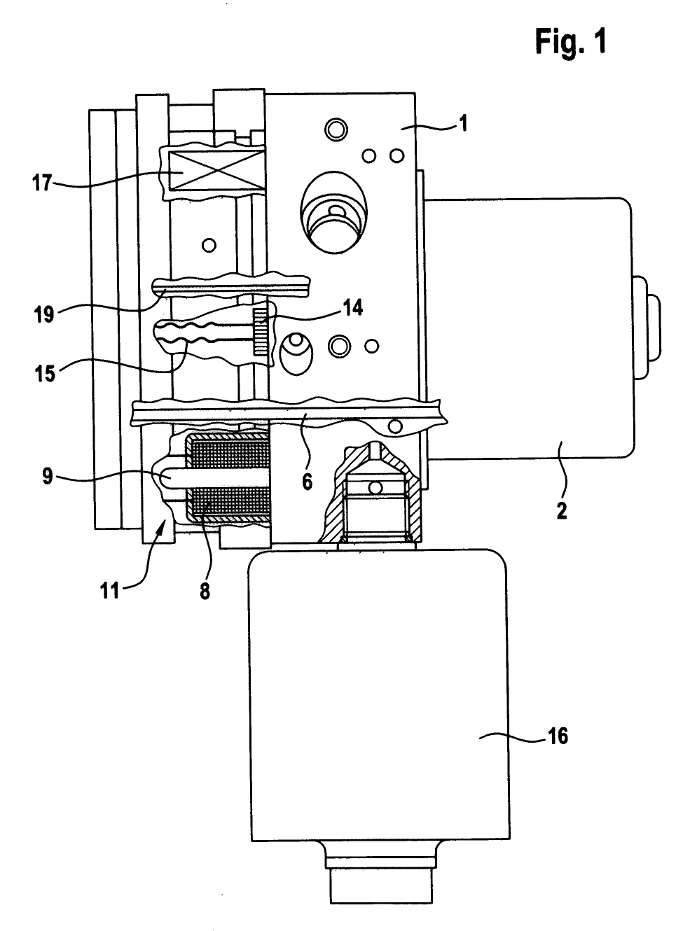

FIG. 1 is a schematic view of a first embodiment of the unit of the invention for an electronically controlled brake system.

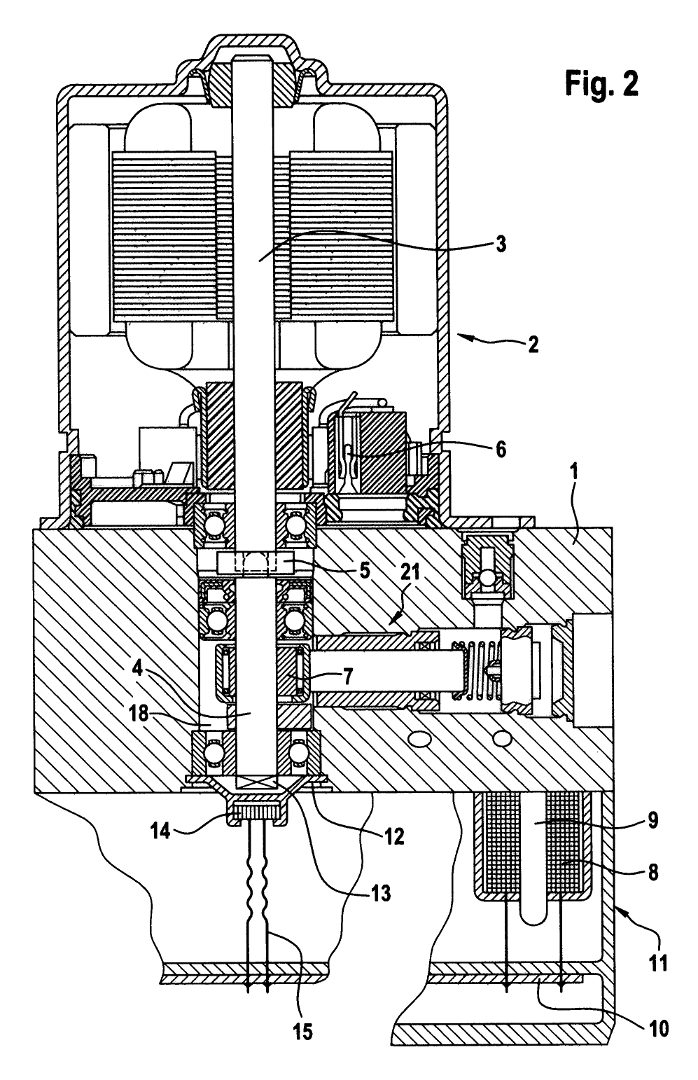

FIG. 2 is a partial cross-sectional view of a second embodiment of the unit of the invention.

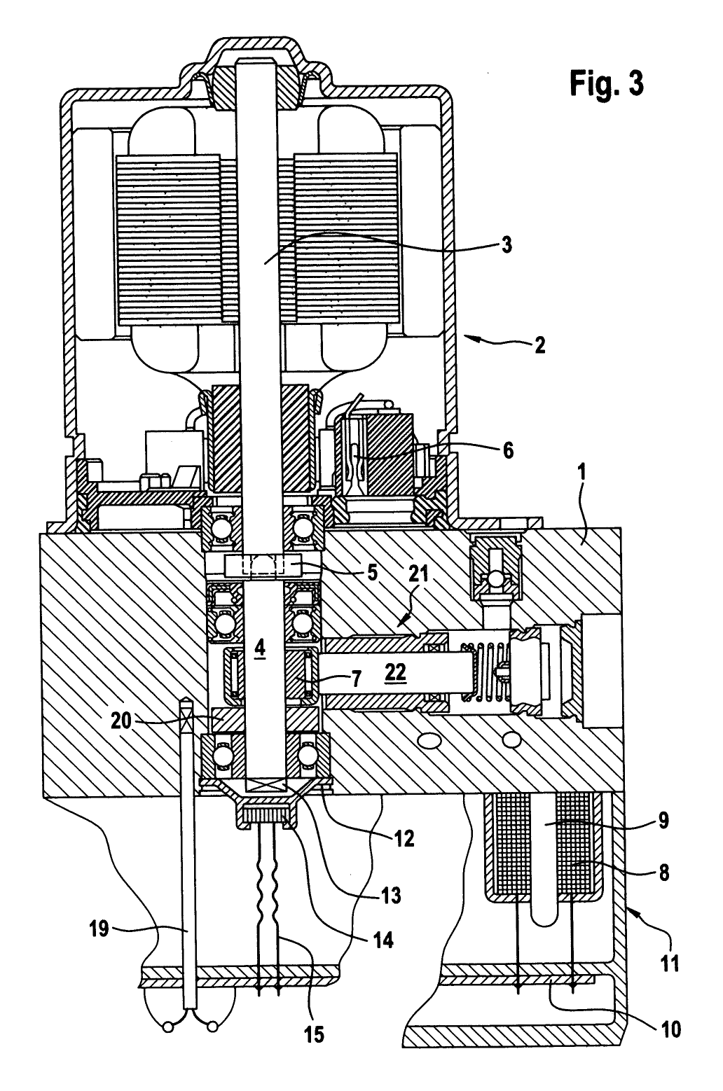

FIG. 3 is a detail view of the embodiment of the unit according to the invention already shown in FIG. 1, likewise in a partial cross-section.

The unit for an electronically controlled brake system illustrated in a schematic side view in FIG. 1 comprises a valve or pump block 1 wherein a pump (not shown) is accommodated that is operated by a shaft of motor 2, also not shown in FIG. 1. The pump delivers hydraulic fluid in a known manner into non-illustrated wheel brakes of the brake system. Motor 2 is provided at one side of the valve or pump block 1 and connected in an electrically conductive way with a controller unit 11 by way of a motor plug 6, that means, the motor 2 is energized and actuated or controlled by way of motor plug 6. The controller unit 11 is arranged on the side of the valve or pump block 1 opposite the motor 2.

Magnetic valves 8, 9 are arranged partly in the controller unit 11 and partly in the valve or pump block 1 in a usual fashion, with valve coils 8 and valve domes 9 of the magnetic valves 8, 9 being housed within the controller housing 11 to the largest extent possible. Also, an accumulator 16 is optionally provided on the valve or pump block 1, said accumulator being required to store the hydraulic fluid especially in brake systems with an electronic stability program (ESP) or electro-hydraulic brake systems (EHB). However, the invention is not restricted to braking systems of this type. Besides, one or more pressure sensors 17 may be provided at the unit.

The unit further comprises at least one sensor for sensing the rotational speed of motor 2 or the shaft thereof, FIG. 1 depicting only one sensor element 14 or 19 of the sensor. Referring to FIG. 1, initially only the sensor with sensor element 14 shall be described. The sensor with sensor element 19 will be explained in detail in the description relating to FIG. 3.

The sensor element 14 of the sensor is provided in the area of the controller unit 11 according to the invention. An electrical contacting 15 between the sensor element 14 and the controller unit 11 thus extends within the controller unit 11 according to this invention, with the result that the need for additional external lines or any other type of electrical contacting through the valve or pump block 1 is obviated compared to a sensor known from the state of the art that is arranged entirely within the motor 2. This feature permits achieving a low-cost, low-weight and small-size unit or motor 2 or valve or pump block 1 and, also, a safe and simple transmission of the rotational speed signal.

Further advantages of the invention become apparent from FIG. 2 showing a unit of the invention, partly in cross-section. The controller unit 11 in particular includes a board 10, and the sensor element 14 is connected preferably directly to board 10 by way of the electrical contacting 15. In the electrical contacting 15, i.e. between sensor element 14 and board 10, a plug connection (not shown) may be provided in particular so that a separation of valve or pump block 1 and controller unit 11 is possible. The controller unit 11 is configured as an independent component according to a particularly preferred embodiment of the invention. Advantageously, the invention makes use of the free mounting space between the valves 8, 9 or between the valve or pump block 1 and the board 10. The arrangement of the electrical contacting 15 or of sensor element 14 further allows reducing interferences in the transmission of the rotational speed signal, and the unit becomes more robust in addition. For example, a greater extent of contamination may be admitted in the area of the motor 2 or of the brushes thereof because the rotational speed signal is not disturbed thereby.

E.g. an optical sensor or a magneto-sensitive sensor with an optical or magneto-sensitive sensor element 14 may be provided as a sensor 12, 13, 14. Possible examples of an optical sensor are sensors functioning by means of laser, infrared, or a photoelectric cell.

Preferably, a coding element 13 of the sensor is unrotatably arranged on the shaft 3 or on components co-rotating with the shaft 3 such as on an eccentric 7 of the pump 21 or on an output shaft 4 that is unrotatably coupled to the shaft 3. The coding element 13 may e.g. be magnetic or include an optical contrast.

Preferably, a cover 12 is provided between the coding element 13 and the sensor element 14. Said cover 12 prevents e.g. hydraulic or lubricating fluid out of a crank chamber 18 of the pump 21 from contaminating or damaging the sensor element 14. This fluid does not necessarily have to be leakage fluid, it is also possible that the crank chamber 18 is completely filled with hydraulic fluid. The cover 12 is especially favorable in this case. Corresponding to the above-mentioned sensor variants the cover 12 may have an anti-magnetic and/or transparent design.

FIG. 3 illustrates an improvement of the present invention, and components that have already been described in connection with FIG. 2 shall not be discussed in detail. In contrast to the preceding embodiment, a coding element 20 is designed like a plate on the output shaft 4, and sensor element 19 may be arranged radially with respect to the coding element 20 and also partly within the valve or pump block 1 that is preferably made from a non-magnetic material such as aluminum.

The sensing operation between coding element and sensor element may also take place in axial (19, 20) and/or radial (13, 14) directions. With the invention it is e.g. also possible for safety reasons to employ a plurality of sensors 12, 13, 14 or 19, 20 that monitor each other or are redundant. Also, the invention allows a sensor (not shown) to sense the movement of the piston 22 of pump 21 instead of the rotation of the shaft 3 or 4, with the rotational speed of motor 2 then being determined from this value.

1. Unit for an electronically controlled brake system including a motor (2) that drives a pump (21) by way of a shaft (3, 4), said pump being arranged in a valve or pump block (1) and supplying hydraulic fluid into wheel brakes of the brake system, and a controller unit (11) provided on a side of the valve or pump block (1) opposite to the motor (2), wherein the unit comprises at least one sensor (12, 13, 14; 19, 20) for sensing the rotational speed of the motor (2) or the shaft (3, 4),
characterized in that at least one sensor element (14, 19) of the sensor (12, 13, 14; 19, 20) is arranged in the area of the controller unit (11).

2. Unit as claimed in claim 1,
characterized in that the controller unit (11) includes a board (10), and the sensor element (14, 19) is connected directly to the board (10) by way of an electrical contacting (15).

3. Unit as claimed in claim 1 or 2,
characterized in that the sensor (12, 13, 14; 19, 20) is designed as an optical sensor (12, 13, 14) or a magneto-sensitive sensor (12, 13, 14; 19, 20).

4. Unit as claimed in any one of the preceding claims,
characterized in that a coding element (13, 20) of the sensor (12, 13, 14; 19, 20) is unrotatably arranged on the shaft (3, 4).

5. Unit as claimed in claim 4,
characterized in that the coding element (13, 20) is magnetic or at least includes an optical contrast.

6. Unit as claimed in claim 4 or 5,
characterized in that a cover (12) is provided between the coding element (13) and the sensor element (14).

7. Unit as claimed in claim 6,
characterized in that the cover (12) has an anti-magnetic and/or transparent design.

8. Unit as claimed in any one of the preceding claims,
characterized in that the controller unit (11) is an independent component.
